(19) United States
(12) Patent Application Publication
(10) Pub. No.: US 2017/0231866 A1
(43) Pub. Date: Aug. 17, 2017

(54) Bottom Bather

(71) Applicant: Tosca Agnese Lenci, Sonoma, CA (US)

(72) Inventor: Tosca Agnese Lenci, Sonoma, CA (US)

(21) Appl. No.: 14/998,751

(22) Filed: Feb. 11, 2016

(51) Int. Cl. A61H 35/00; A47K 7/08; A47K 1/04; A47K 3/28

(52) U.S. Cl. CPC A61H 35/00; A47K 3/282; A47K 7/08; A47K 1/04

(57) ABSTRACT

This invention named “Bottom Bather” is a basin seat for a shower stall, has its own drain, can be filled by shower wand or provided with self water supply. It also is modifiable for installation in a bathtub.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING

Not Applicable.

### BACKGROUND OF INVENTION

This concept arose from inventor's hands-on experiences with aging family members and observations in nursing homes related to realistic practical, efficient assistance in caring for aged and/or disabled bodies lacking autonomous control of bladder and bowel functioning. It embraces (1) primary hygienic advantages for cleansing and treating genitalia, perineum, inner buttocks, and anus in situations of incontinence; (2) safely enables convenient and medically healing soaking as well as cleansing, when a full bath is unmanageably unsafe due to physical incapacities; (3) seatedly accommodates full showering with water wand when installed in a shower stall; (4) can be constructed also simply for use over a toilet, into which it then would drain, and filled by a nearby water wand from tub or shower; and (5) obviates difficulties of “walk-in” bath tubs as to waiting for filling and body chilling while emptying.

B. Invention pertains to the Human Necessities category, which includes the following classifications:
A47C CHAIRS, shower stall seats (A47C 7/02, seat adaptation parts).
A47K SANITARY EQUIPMENT NOT OTHERWISE PROVIDED FOR; TOILET ACCESSORIES—connections to water supply or waste pipe (A47K 3/12, 3/28).
A61 HYGIENE
   A61G Basin soaking seat for urogenital cleansing and soaking.
   A61J TOILET PURPOSES—administration of water-soluble disinfectants and/or curing treatments for skin and tissue irritations or infections of targeted areas (A61J 3/00).

### BRIEF SUMMARY OF THE INVENTION

“Bottom Bather” is a basin seat with self-drain and optional self water supply, installed in a shower stall or as a chair to place over a toilet. If a self-water supply is not incorporated, a shower water wand would supply water to fill basin if Bottom Bather is installed in a shower stall, or a nearby bathtub or shower water wand would supply water to fill basin if the toilet chair is utilized). Bottom Bather also can be modified in its construction for installation in a bathtub.

In whatever its form, the unit most efficiently and conveniently augments cleanliness and maintenance of hygiene in cases of elderly and/or disabled individuals with bladder and/or bowel incontinence, also for treatment of related conditions such as infections and associated skin and tissue problems—altogether, effecting general and specific perineal hygiene and health. Bottom Bather obviates laborious sponge-bathing or frequently-repeated, difficult full showering, as well as waits for “walk-in” tub filling and emptying. It also obviates laborious sponge-cleansing in situ, by care-giving and nursing staff, and especially reduces laundering of soiling linens.

### BRIEF DESCRIPTION OF THE SEVERAL VIEWS OF THE DRAWINGS

[Note: More formal drawings in process, when complete, will be added to this filing by form PTO/SB21,] Herewith:

FIG. 1:

FIG. 1-A—Bottom Bather basin seat designed for tubular-post-supported construction.

FIG. 1-B—Bottom Bather basin seat of solid ‘pedestal’ form consisting of various possible compositions (ceramic, stone, etc.).

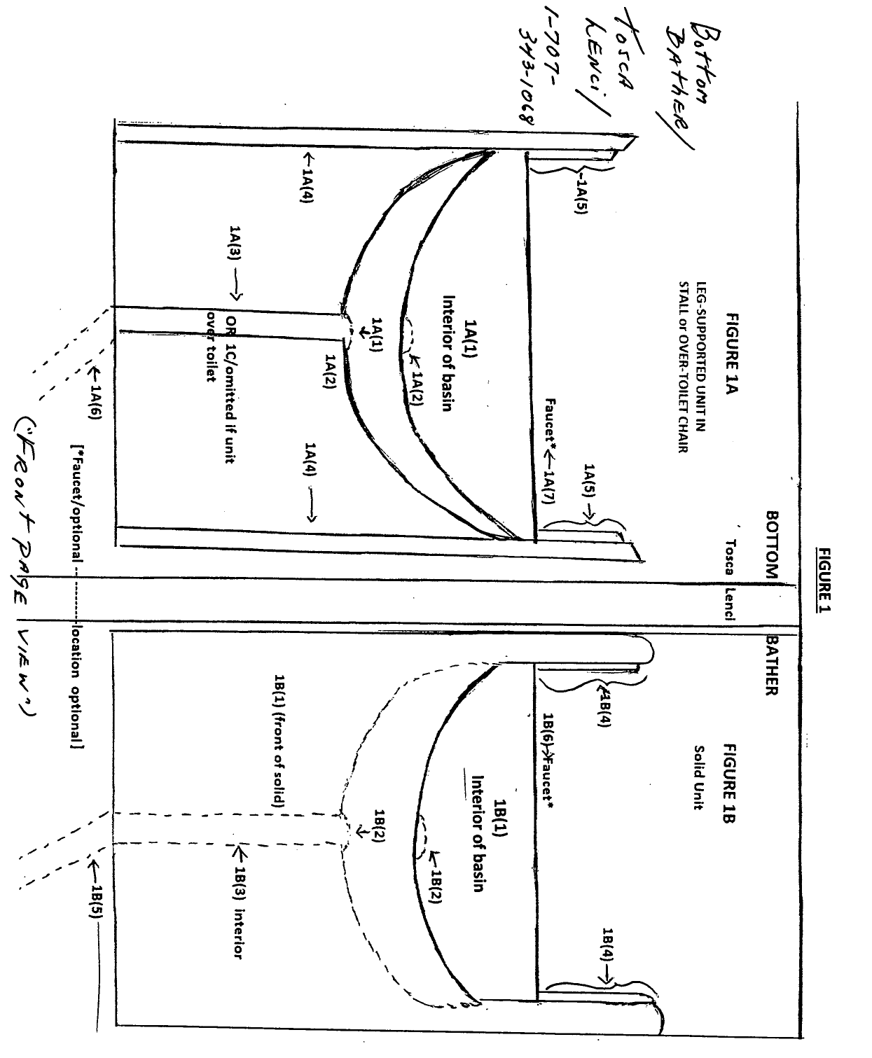

FIG. 1-A—Bottom Bather basin supported by legs installed in stall and also showing drain pipe omission (1C) if constructed as a over-toilet chair.
1-A (1)=basin.
1-A (2)=basin drain.
1-A (3)=drain pipe from basin drain to sub-floor main drain piping.; omitted if unit is constructed as an over-toilet chair.
1-A (4)=basin supporting legs.
1-A (5)=arm rests.
1-A (6)=sub-floor pipe to main drain if shower stall install.
1-A (7)=spigot/faucet if self-water supply is incorporated in a stall installation.

FIG. 1-B—A solid Bottom Bather unit constructed in shower stall.
1-B(1)=basin interior, exterior, and solid base.
1-B(2)=basin drain.
1-B(3)=interior drain pipe.
1-B(4)=arm rests.
1-B(5)=sub-floor pipe to main drain.
1-B(6)=spigot/faucet if self-water supply is incorporated in the installation.

### DETAILED DESCRIPTION OF THE INVENTION

Bottom Bather basin installation requires only standard, prefabricated plumbing piping and drainage parts.

Order of carrying out invention depends on the model chosen, determining whether:

(1a) construction is to be part of a completely new shower stall construction, added to an existing stall, replace an existing simple seat in an existing stall, or as an over-the-toilet unit.

(1b) Determine whether Bottom Bather basin will utilize a self-water supply or be filled by a shower or bath tub water wand.

(1c) Determine whether bottom bather basin will be supported upon legs (such as tubular aluminum or steel—Drawing FIG. 1-A), or whether basin will be atop of and part of a solid base seat (such as ceramic or stone—Drawing FIG. 1-B).

(1d) If solid seat base with basin is intended (Drawing FIG. 1-B), obtain manufacture of plumbing-adaptable unit with appropriately-sized basin, interior drain pipe, and applied arm rests.

(1e) If leg-supported, secure supply or production of adaptable basin of suitable material, and appropriate fittings, etc.for legs and arm rests.

(1f) Secure all requisite standard piping and assembly parts for chosen model and operation, including connections for drainage and, if intended, for self-water supply for basin.

(2) Prepare flooring area to receive delivery of basin drain pipe to shower stall drain. If self-water supply for basin is intended, prepare wall and/or floor areas for planned pipe conveyance of water from bathroom main water source to basin spigot. If a solid base is used, measure and mark place at subfloor where drainage extension from base will meet piping to main drain.

(3) Assembling and positioning “Bottom Bather:”

(a) If leg-supported unit (FIG. 1-A) measure proper seating height of unit legs and affix to basin seat. Construct and affix arm rests of material identical to leg supports. If in a shower stall, measure and construct pipe from basin drain down to meet sub-floor piping that will lead to main shower drain. Measure appropriate sub-floor length of piping to run from end of basin drain pipe to shower stall drain.

(b) If solid seat and base (FIG. 1-B), measure and construct sub-floor piping from bottom of base interior drain pipe to meet main shower drain. Complete connections.

(c) If self-supply water source is planned, construct piping from main shower water source to, and install basin spigot.

1. Bottom Bather is a unique basin-seat unit with self-drain and optional self-water supply, permanently installable in a shower stall or as a separate placeable unit in a shower stall, for cleansing and medical soaking of the body's genito-uro and perineal regions, primarily important as to elderly and disabled individuals subject to bladder and bowel incontinence. It also permits a seated occupant to obtain full showering concomitantly with shower water wand.
Bottom Bather further allows efficient disinfecting and skin treatments; obviates major expense and drawbacks of “walk-in” ‘tub installations.
“Bottom Bather” is not to be confused with “bidets” of varying constructions, which do not allow hygienic or medical soaking but utilize only direct water application via differently-adapted nozzles, and require changes in user's bodily position to accommodate cleansing.
